(19) United States
(12) Patent Application Publication
(10) Pub. No.: US 2022/0380136 A1
(43) Pub. Date: Dec. 1, 2022

(54) EJECTOR FINGER FOR A DEVICE FOR SUPPLYING SORTED CLOSURE ELEMENTS AND METHOD FOR MANUFACTURING BY MOLDING

(71) Applicant: SIDEL PARTICIPATIONS, OCTEVILLE-SUR-MER (FR)

(72) Inventors: Daniel SPIESSER, Reichstett (FR); Emmanuel ROTH, Reichstett (FR)

(21) Appl. No.: 17/626,693

(22) PCT Filed: Jul. 15, 2020
(86) PCT No.: PCT/EP2020/069940

§ 371 Date: Jan. 12, 2022

(30) Foreign Application Priority Data
Jul. 16, 2019 (FR) 1908001

(51) Int. Cl. B65G 47/14; B65G 47/82; B65G 15/44; B29C 45/14; B67B 3/064

(52) U.S. Cl. CPC B65G 47/1478; B65G 47/82; B65G 15/44; B29C 45/14; B67B 3/0645; B29K 2705/12

(57) ABSTRACT

The present invention concerns an ejector finger for ejecting closure elements, comprising a body provided with a base and, on the opposite side, a distal end comprising a front zone for coming into contact with the closure elements to be ejected, and the at least one distal end comprises an insert provided with at least one surface dimensioned so as to at least partially cover the front zone. The invention also concerns a device for supplying sorted closure elements, with ejector means comprising at least one such finger. The invention further concerns a method for manufacturing the ejector finger by molding.

The present invention lies in the field of supplying sorted closure elements in order to supply a downstream workstation on a production line.

Such closure elements consist in caps or capsules intended to close containers, in particular flasks or bottles, made of plastic, glass or metal, in particular of aluminum. Said closure elements may be made of any type of material, in particular of plastic or of metal.

Furthermore, a container comprises an opening, in the form of a lip, generally situated in the upper part of a neck. After filling, the opening of a container is hermetically closed by means of a closure element, such as a capsule or a cap. A closure element of this kind has a flattened tubular overall shape, resembling a hollowed out disk. The closure element is closed by a concave bottom in order to receive internally a seal making the seal when positioned in contact with the lip.

In the context of the present invention, unless otherwise specified, the terms “closure elements”, “caps” and “capsules” are equivalent.

In known manner, the supply of closure elements, in the form of caps, is effected by means of a sorting module, commonly known as a “cap-feeder”. This kind of sorting module receives as input said caps tipped loose into a storage unit such as a hopper. This module handles, on the one hand, the sorting of these caps in order to dispose them in an appropriate position and, on the other hand, supplying continuously with sorted caps a workstation situated downstream on the production line. The principal role of this kind of downstream workstation is to fit, and/or to close the containers by means of, the sorted caps. For example, said downstream workstation may consist in a bottling module provided with a unit for capping the containers or a unit for sterilizing said closure elements.

In other words, a sorting module makes it possible to take up initially randomly oriented caps and to orient all those caps correctly, in a regular and continuous flow supplying at least the downstream workstation the function of which is to close each container by means of a cap. Moreover, this kind of sorting module enables control of the conformance of the closure elements, in particular the dimensions, one or more colors, the integrity, the possible presence of a tamper evident ring, etc.

One existing sorting module comprises in the lower part a storage unit receiving the loose closure elements and, dipping into said storage unit, an elevator conveyor generally formed of an endless belt oriented vertically and driven in such a manner as to extract and to lift said caps. To be more precise, said belt includes on an exterior face a succession of cleats juxtaposed over its length. Said cleats take the form of flat bars of globally rectangular parallelepiped shape. Such cleats are spaced to form housings extending transversely from one side to the other of said belt, the spacing between two cleats approximately corresponding to the diameters of said caps to be taken up in the storage unit. Moreover, the inclination of the belt, the configuration and the dimensions of said cleats assure particular positioning of the caps taken up.

Indeed, a cap taking up a position in a housing with a configuration other than the one required, for example upside down or out of line, finds itself unbalanced, is tipped out of its housing and falls naturally under gravity as the vertical movement of said conveyor continues. Accordingly, once arrived at the end of travel, there remain in the housings only the caps oriented with the chosen configuration. This sorting technique is commonly known as “waterfall” (in French “chute d′eau”).

Once sorted and aligned, the caps present in each housing that have arrived in the upper part of the device are sent sequentially to a supply station. To this end, a number of existing systems may be used, employing means for successive ejection of each row of aligned caps contained in each housing. Such ejector means may be pneumatically operated, in the form of a jet of compressed air oriented in the same manner, thus propelling the caps toward the extraction end. The ejector means may be mechanical, in the form of at least one pusher or “ejector finger” mounted to be mobile in longitudinal translation along and inside each housing, from one end to the opposite, extraction end, pushing each row of caps toward that outlet end.

The invention is aimed in particular at this kind of mechanical ejection.

One example of mechanical ejector means is known in particular from the document WO 2016/108026 describing ejector fingers mounted on a belt, forming an endless strip, driven in a manner synchronized with the upward movement of the belt, so as to induce movement of each finger along a housing that has arrived in the upper part of the elevator conveyor.

Furthermore, each ejector finger comprises a body provided with a base and on the opposite side a distal end. The latter features a front zone intended to come into contact with the last closure element of a row to be ejected.

Because of a number of constraints, the body is generally made in one piece from a composite, in particular plastic, material. Indeed, the finger must have some elasticity in order not to damage the caps when it comes into contact with them or when it is pushing them along the housing. Moreover, in the event of a jam occurring at the moment of ejection of the caps present in a housing, the finger must be able to deform, in bending, sometimes as much as breaking, in order to avoid damaging other components of the ejector means or of the supply device. The finger being an attached part fixed onto the belt, it is easier, faster and above all less costly to replace it, rather than other components of the device.

In a related manner, the weight of the plastic material of an ejector finger also limits the centrifugal force to which it is subjected during each passage around the idler pulleys of said belt.

In this context, a problem arises in terms of wear of the ejector fingers, in particular because of the abrasion suffered by the front zone in contact with the closure elements. This abrasion is all the more pronounced if the closure elements are made of metal, as in the case of capsules, for example of “crown cap” type (in French “couronne”).

An object of the invention is to alleviate the disadvantages of the prior art by proposing to improve the resistance to abrasion of the front zone of an ejector finger whilst preserving the elasticity of its body, required for correct operation of the supply device and preventing all risk of damage in the event of a malfunction.

To this end, the invention envisages adding an insert at the level of the distal end provided with a front surface coming at least partly to cover the front zone of contact of said finger. The material of said insert is made more resistant, limiting abrasion and increasing the service life of this kind of finger.

Accordingly, in accordance with the invention, this kind of ejector finger comprises Finger for ejecting closure elements, comprising:
a body provided with a base and, on the opposite side, a distal end;
said distal end comprising a front zone for coming into contact with one of said closure elements to be ejected.

This kind of ejector finger is characterized in that at least the distal end comprises an insert provided with at least one front surface sized so as at least partially to cover said front zone.

In accordance with additional, non-limiting features, this kind of finger may comprise a means for fixing at least said front zone with the front surface, said fixing means comprising a core extending at least in part inside said distal end.

Said core may comprise at least one orifice situated inside said distal end.

Said orifice may be a through-orifice.

Said insert may comprise a rear surface, said front surface and said rear surface being connected by said core.

Said insert may comprise at least one rounded edge.

Said finger may comprise at least one chamfer reentrant from said base to said distal end.

Said body may be made of a composite material, in particular of plastic material, whereas said insert is made of metal, in particular of stainless steel.

The invention also concerns a device for supplying sorted closure elements provided with this kind of ejector finger.

In particular, said supply device comprises:
a volume for bulk storage of said closure elements;
an elevator conveyor in the form of a belt provided with an ascending run penetrating said storage volume;
said elevator conveyor comprising on its exterior face a plurality of cleats oriented transversely relative to said belt and spaced in such a manner as to determine a housing between two adjacent cleats, each housing taking up a plurality of said closure elements during its passage inside said storage volume;
mechanical means for ejecting the closure elements present in each housing on reaching the upper part of said elevator conveyor.

Advantageously, said ejector means comprise at least one ejector finger as claimed in any one of preceding claims.

In accordance with additional, non-limiting features said device may comprise means for moving said ejector means, said movement means comprising a belt supporting the base of said at least one finger.

The invention further concerns a method of manufacturing this kind of ejector finger by molding or by addition of material.

Furthermore, this kind of method of manufacture may be effected by molding and in that:
said insert is loaded into a mold;
said insert is overmolded by injection of a composite or plastic material into said mold.

Other features and advantages of the invention will emerge from the following detailed description of non-limiting embodiments of the invention with reference to the appended figures, in which:

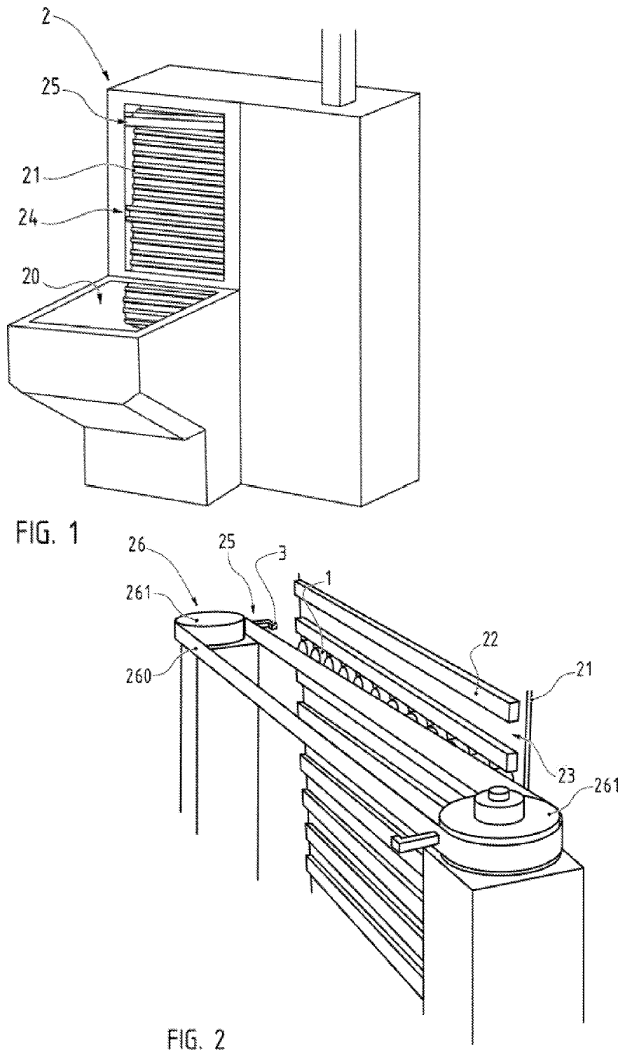

FIG. 1 represents schematically a view in perspective of one embodiment of a device for supplying sorted closure elements, showing in particular the elevator means with a plurality of cleats forming housings picking up closure elements on passing through a storage volume situated in the lower part;

FIG. 2 represents schematically a view in perspective of a specific embodiment of ejector means of a supply device, showing in particular ejector fingers mounted under a belt driving said fingers along a housing that has arrived in the upper part;

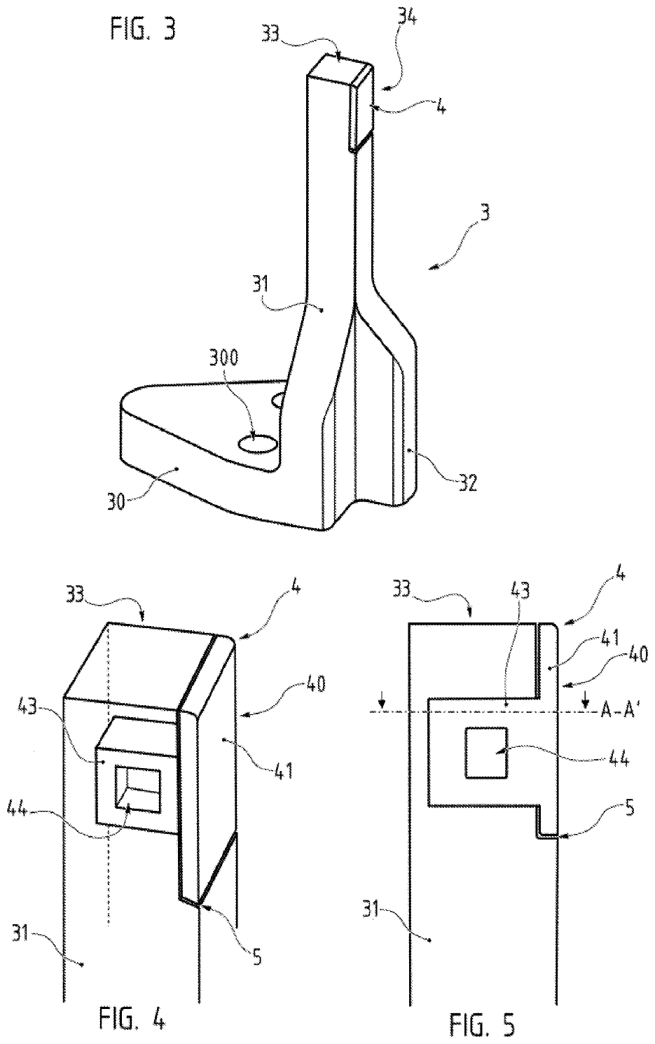

FIG. 3 represents schematically a view in perspective of one embodiment of an ejector finger, showing in particular a distal end provided with an insert with a front surface;

FIG. 4 represents diagrammatically a view partly as is transparent of a detail of FIG. 3, showing in particular the core of the insert provided with two aligned non-through orifices;

FIG. 5 represents schematically a view in vertical section of FIG. 4, showing in particular the front surface of the insert integrated in the front contact zone of the body via a reentrant chamfer;

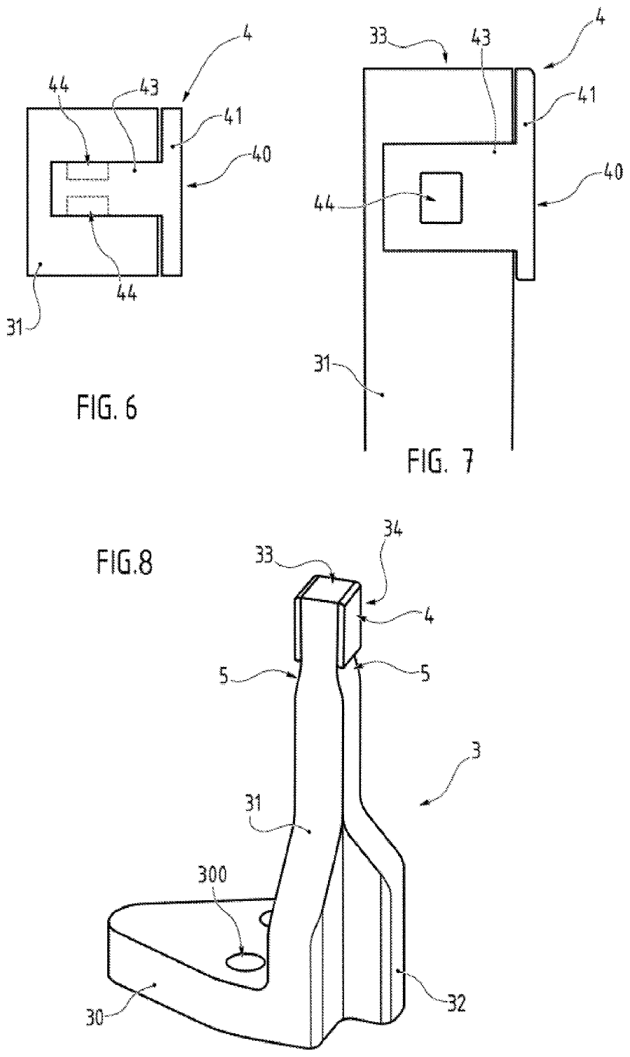

FIG. 6 represents schematically a view in horizontal section of FIG. 5 taken along the line A-A′;

FIG. 7 represents schematically a view in vertical section of a variant embodiment with no chamfer;

FIG. 8 represents schematically a view in perspective of another embodiment of an ejector finger, showing in particular a distal end provided with an insert with a front surface and an opposite rear surface;

FIG. 9 represents schematically a view partly as if transparent of a detail of FIG. 8, showing in particular the core of the insert connecting the front and rear surfaces, rounded chamfers at the front and at the rear, as well as a core with a through-orifice;

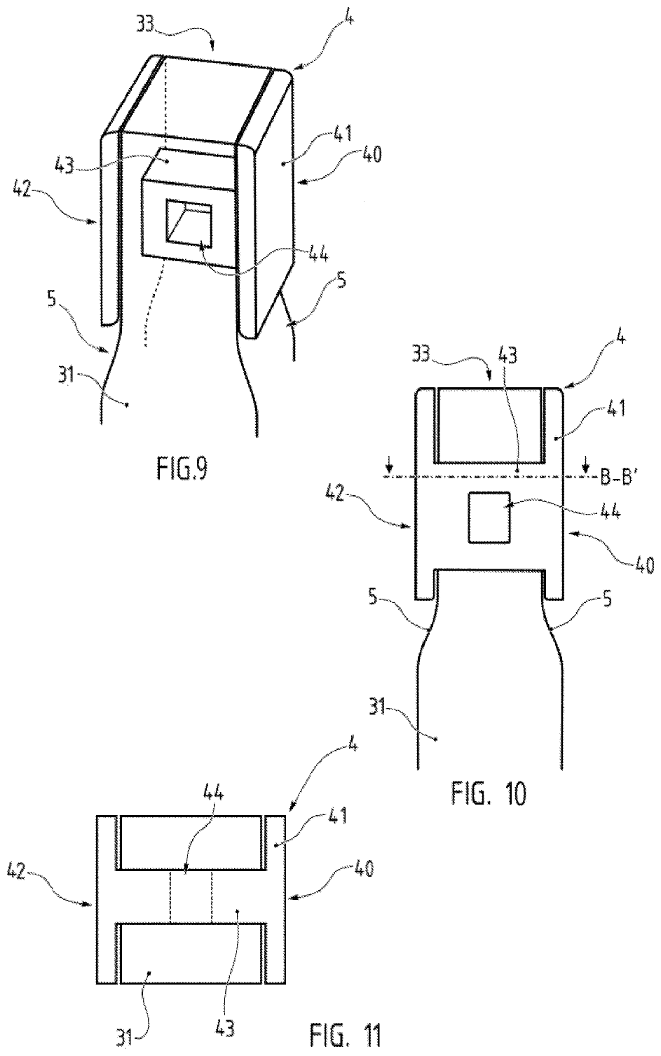

FIG. 10 represents schematically a view in vertical section of FIG. 9; and

FIG. 11 represents schematically a view in horizontal section of FIG. 10 taken along the line B-B′.

The present invention concerns the ejection of closure elements 1.

Such closure elements 1 may consist in caps or capsules intended to close containers, in particular flasks or bottles, made of plastic, glass or metal, in particular of aluminum. Said closure elements may be made of any type of material, in particular of plastic or of metal.

FIG. 2 shows in particular caps aligned in a row ready to be ejected.

Such ejection enables caps to be supplied in an in particular continuous and oriented stream to at least one workstation located downstream.

The supply of closure elements is effected by means of a specific sorting module commonly called a “cap-feeder”. This kind of sorting module receives as input said caps loose and, on the one hand, sorts these caps in order to dispose them in a position that is, on the other hand, suitable for supplying sorted caps to the workstation downstream on the production line. The principal roles of this kind of downstream workstation are to fill the containers and then to close them by means of the sorted caps. For example, said downstream workstation may consist in a bottling module provided with a unit for capping the containers or a unit for sterilizing said closure elements.

In order to supply the downstream workstation with caps, the invention concerns a device 2 for supplying sorted closure elements 1.

This kind of device 2 comprises a volume 20 for loose closure elements 1. This kind of storage volume 20 may take the form of a hopper into which the caps are tipped.

The device 2 also comprises an elevator conveyor 21. This kind of conveyor takes the form of a belt provided with an ascending run penetrating said storage volume 20. This kind of belt is preferably an endless strip passing around idler rollers at least one of which is motorized. The conveyor 21 extends vertically or substantially vertically, moving the caps in a generally vertical direction.

To this end, said elevator conveyor 21 comprises on its exterior face a plurality of cleats 22 oriented transversely relative to said belt. These cleats 22 are spaced in such a manner as to determine a housing 23 between two adjacent cleats 22, with the result that each housing 23 picks up a plurality of said closure elements 1 during its passage in said storage volume 20.

To be more precise, on the exterior face of the belt the plurality of cleats 22 are oriented horizontally or substantially horizontally and spaced in such a manner as to determine the housings 23 between the upper edge of a lower cleat and the lower edge of an upper cleat, the spacing between the bottom of the top cleat and the top of the bottom cleat being determined as a function of the caps to be processed by the device 2. At the time of the passage of the belt in the volume 20, caps are then inserted in each housing 23 and are moved along the ascending run.

The device 2 may additionally comprise a means 24 for sorting imbalanced caps present in their housing 23, said sorting means cooperating with the movement of said elevator conveyor 21 in such a manner as to cause incorrectly oriented caps present in their housing 23 to fall out. To summarize, during the vertical movement a first inherent sorting of the caps is effected because of the dimensions of the housings 23 and the inclination of the conveyor 21. Caps that are incorrectly oriented, in particular upside down, are imbalanced and fall out of their housing 23 into the storage volume 20 by gravity.

Such sorting can be accentuated by a localized change of inclination of the conveyor 21, for example in the form of a boss situated at a height of the conveyor 21, similar to a “donkey's back”. A donkey's back sorting means 24 of this kind can be seen in FIG. 1 in particular.

Such sorting can also be carried out by other means, such as by vibrations transmitted to the belt or to the cleats 21, or again by means of air pulsed or blown toward the housings 23.

The device 2 further comprises means 25 for ejecting the closure elements 1 present in each housing 23 when it arrives in the upper part of said elevator conveyor 21.

In the context of the present invention, the ejector means 25 are mechanical.

To this end, said ejector means 25 comprise at least one ejector finger 3. Said ejector means 25 may comprise a plurality of fingers 3, in particular at least two ejector fingers 3.

Said ejector means 25 preferably comprise only one finger 3.

The device 2 preferably comprises driving means 26 for moving said ejector means 25.

Such driving means 26 provide in particular for the mobility of each finger 3 along and inside each housing 23 when it arrives in the upper part of the device 2. The actuation of the movement means 26 is synchronized with the upward movement of the elevator conveyor 21. The movement of a finger 3 inside the housing is therefore effected transversely or substantially transversely, i.e. follows a horizontal overall trajectory with a vertical component due to the upward movement of said elevator conveyor 21, in such a manner as to follow transversely the interior of the housing situated facing the ejector means 25.

Each finger 3 during its movement inside a housing 23 then comes into contact with the closest cap present and comes to push all the row of caps contained in said housing 23, by virtue of the caps touching one another, in the direction of said movement of said finger 3, until all the caps of said row are ejected on the opposite side of said finger 3.

Moreover, the ejection of each row of caps is effected in particular via a dedicated opening present at this location, in the upper part of the device 2.

It will be noted that said device 2 may comprise downstream dedicated modules in particular enabling referencing of the flow of ejected caps in order to send a regular, in particular continuous, stream of caps to the downstream workstation.

In accordance with one embodiment, visible in FIG. 2, said movement means 26 comprise a belt 260 supporting at least one finger 3, in particular a base 30 of said at least one finger 3.

Said belt 260 receives a removably fixed finger 3 or plurality of fingers 3 at regular intervals. Moreover, said belt 260 may receive two fingers 3, then placed in opposition, as can be seen in FIG. 2.

Moreover, said belt 260 may be an endless belt. Said belt 260 passes around rollers or sprockets 261, of which at least one roller 261 is motorized and drives said belt 260 and therefore the movement of the finger or fingers 3.

In this regard, the invention is particularly directed to the finger 3 for ejecting closure elements 1.

This kind of ejector finger 3 comprises a body 31. Said body 31 may have any shape, in particular any elongate shape, with an in particular polygonal, preferably square, section. The body 31 has at least one front face, situated on the downstream side with reference to the direction of movement, i.e. the front face is oriented toward the caps to be ejected. Also, the body 31 has at least one rear face situated opposite the front face.

Moreover, said body 31 is provided with a base 30.

As mentioned above, this kind of base 30 can serve as an element for fixing the finger 3 to the movement means 26, in particular by means of holes 300 intended to cooperate with fixing elements (not represented).

This kind of base 30 can have any shape or section, extending essentially orthogonally relative to the rest of the body 31.

One embodiment of a base 30 is more particularly seen in FIGS. 3 and 8.

Moreover, in accordance with one particular embodiment, the body 31 may comprise on its front face a surplus 32 of material having in particular the function of stiffening the finger 3, reducing its elasticity and preventing the risks of breaking in the event of strong twisting. This kind of surplus 32 may be of any shape. One example of a surplus 32 is represented in FIGS. 3 and 8 in particular.

In this regard, at least said body 31 of the finger 3 may be made of a composite, resin or plastic material offering flexibility but also a stiffness required, on the one hand, to push on a row of caps and, on the other hand, to retract by deforming, or even breaking, in the event of jamming of the caps at the moment of their ejection, in order to avoid the risks of damaging other components of the device 2, such as for example the belt 260 or the cleats 22, or one of the drive systems of the device 2. The elasticity of the body 31 therefore assures flexible contact against the first cap of the row to be ejected, preventing damage.

In this regard, on the side opposite said base 30 said finger 3 has a distal end 33. It is this distal end 33 that comes to push on the nearest cap at the time of ejection.

To this end, said distal end 33 comprises a front zone 34 that contacts one of said closure elements 1 to be ejected, i.e. with the closure element 1 present in a housing 23 and situated nearest to the finger 3.

It will be noted that the zone 34 is understood to be a front zone relative to the direction of movement of said finger 3.

In order to increase the strength of said front zone 34, in particular against abrasion in contact with the caps, the invention advantageously provides for reinforcing at least a part of the distal end 33 at the level of said front zone 34.

To this end, the distal end 33 includes an insert 4. The insert 4 is therefore included in the finger 3.

This kind of insert 4 is therefore preferably made of a stronger material than the material constituting the rest of the body 31 of the finger 3.

Moreover, said body 31 may be made of a composite material, in particular of plastic material, whereas said insert 4 is made of metal, in particular stainless steel or surgical steel.

The insert 4 is advantageously provided with at least one front surface 40 sized to cover said front zone 34 at least partly. In other words, said front surface 40 has dimensions determined so as to extend over the front face 34 of the distal end 33, in particular at least at the level of a portion situated at the level of the point or points of contact with the first cap of the row to be ejected.

In accordance with the various embodiments, represented in particular in FIGS. 3 to 7, said insert 4 has only one front surface 40.

Moreover, this kind of front surface 40 may take the form of a plate 40. That plate may have a rectangular or square parallelepiped overall shape. Said plate 40 may be sized in accordance with the dimensions of the distal end 33 of the body 3, in particular having the same width, as can be seen in FIG. 6 in particular.

In accordance with other embodiments, represented in particular in FIGS. 8 to 11, said insert 4 includes a front surface 40 and a rear surface 42. Said rear surface 42 is situated opposite said front surface 40, on the rear face of the finger 3, and in particular makes it possible to balance the insert 4. The symmetry of the front surface 40 and rear surface 42 very specifically enables compensation of part of the centrifugal force to which the insert 4 is subjected during the passage between the out and return runs in the case of drive by belt 260, compared an imbalance for an insert 4 provided only with a front surface 40.

Said rear surface 42 may be sized approximately like the front surface 40, or be larger or smaller, and even more or less thick.

The front surface 40 is preferably mounted on the body 31. To this end the finger 3 may include a means of fixing at least said front zone 34 to the front surface 40. Moreover, a similar fixing means may be used to mount the rear surface 42 on the rear face of said body 31.

This kind of fixing of the front surface 40 and/or the rear surface 42 may be effected by gluing or by hotmelt gluing, using an appropriate resin or glue.

Said fixing means preferably includes a core 43 extending at least in part inside said distal end 33. In other words, the core 43 is enclosed in the interior of the body 31 of the finger 3. It may extend over a part of its width, as represented in the embodiments from FIGS. 5 to 7 in particular.

In accordance with the preferred embodiment, represented in FIGS. 9 to 11, the core 43 extends the full width of the distal end 33 of the body 30 of the finger 3. The core 43 then connects said front surface 40 and said rear surface 42. To sum up, the core 43 passes completely through the distal end 33.

The core 43 enables improvement of the retention of the insert 4 in the material of said finger 3, in particular the fixing of the inclusion of the insert 4 at the time of manufacturing said finger 3.

In this regard, in accordance with various embodiments, said core 43 may include at least one orifice 44 situated in the interior of said distal end 33. In other words, said at least one orifice 44 is on a portion of the core 43 surrounded by the material of the distal end 33. Moreover, said at least one orifice 44 is filled by the material constituting said distal end 33.

An orifice 44 may have any polygonal, parallelepipedal, rectangular or square, or again rounded, in particular circular, section.

An orifice 44 may be a blind hole, as can be seen in the embodiment from FIG. 6 in particular.

The core 43 may also include a plurality of orifices 44, disposed at different levels on said core 43. Moreover, two orifices 44 may be oppositely aligned, i.e. have the same median longitudinal axis, as can be seen in the embodiment from FIG. 6 in particular. Said at least one orifice 44 is preferably a through-orifice, i.e. extends transversely and is open on each side of the core 43. This kind of through-orifice 44 can be seen in FIGS. 9 and 11 in particular.

Moreover, said at least one orifice 44 may extend in any direction relative to the core 43, transversely relative to its median axis, in particular and preferably horizontally and/or orthogonally relative to said median axis of said core 43.

In accordance with another feature, said insert 4 may have projecting sharp edges, but preferably has at least one rounded edge, in particular a plurality of them. Said at least one rounded edge may be situated at the level of any part of said insert 4, in particular at the level of the orifice 44, of the core 43, or even of the plate 41 of the front surface 40 and/or the rear surface 42.

In accordance with different embodiments, the finger 3 may include at least one chamfer 5 reentrant from said base 31 toward said distal end 33. This kind of chamfer 5 is therefore situated under or at the junction with said front zone 34, as can be seen in FIGS. 4 and 5 in particular or in FIGS. 9 and 10. Said at least one chamfer 5 is reentrant, i.e. it penetrates toward the interior of the material of said finger 3, in particular of the distal end 33.

In the embodiments that can be seen in FIGS. 3 to 5, the finger 3 includes a single chamfer 5 at the level of the front face to receive said plate 41 of the front surface 40 of the insert 4. In accordance with the embodiment represented in FIGS. 8 to 10 the finger 3 includes two chamfers 5 situated on the front face and the rear face of said finger 3, respectively receiving the plates 41 of the front surface 40 and of the rear surface 42.

Said at least one chamfer 5 in particular enables positioning of the plate 40 of the front surface 40 and/or of the rear surface 42 at least partly inside the body 31, relative to its front or rear face.

Said at least one chamfer 5 is preferably sized so as to position the front surface 40 and/or the rear surface 42 flush with the front and rear faces of said finger 3, respectively.

FIG. 7 shows in particular a different embodiment of a finger 3, with no chamfer 5. The plate 41 of the front face 40 then comes to rest directly on the front face of the front zone 34.

In accordance with the embodiment seen in FIG. 4, said at least one chamfer 5 includes a slightly inclined bevel toward the distal end 33.

In accordance with the embodiment seen in FIG. 5, said at least one chamfer 5 includes a bevel extending orthogonally relative to the front face of the body 31 of the finger 3.

In accordance with the embodiment seen in FIGS. 9 and 10, said at least one chamfer 5 is curved.

The invention also concerns a method of manufacturing an ejector finger 3 as described above.

This kind of method of manufacture can be effected by addition of material.

In particular, all or a part of the ejector finger 3 may be produced by depositing material, in particular in successive layers or strata. This kind of deposit can be effected by a three-dimensional printing (3D printing) operation. The layers deposited may be of one material or a plurality of different materials, such as a composite, resin or plastic material, or even a metal. In particular, the body 31 of the ejector finger 3 may be produced by depositing layers of composite or plastic material whereas the insert 4 may be in one piece or comprise a plurality of elements or parts fastened together. The insert 4 may be made and/or assembled beforehand. Said insert 4 preferably consists of a single machined or molded part that is then positioned during production of said body 31 by addition of material in order for said insert 4 to be at least partly enclosed in said body 31. In particular, the core 43 of said insert 4, in particular said at least one orifice 44, is found to be incorporated in the layers successively deposited during the production of said body 31.

Another technique for fabrication of the ejector finger 3 may consist in a molding fabrication process.

As mentioned above, the insert 4 is made beforehand and then attached in such a manner as to be incorporated in the material of said body 31 during its production.

To this end, said insert 4 is preferably loaded into a mold after which said insert 4 is overmolded by injection of a composite or plastic material into said mold. The mold therefore determines the final shape of the body 31, which will incorporate the insert 4 placed before the injection of the material to be molded, in particular by injection molding. The body 31 is then in one piece, incorporating the insert 4, in particular its core 43, embedded in the material trapped in said at least one orifice 44. This molding production technique improves the retention of the insert 4 relative to the body 31 as well as the homogeneity of the material of said body 31 so as to obtain the required mechanical characteristics, in particular the impact strength, elasticity and yield strength of the finger 3 produced in this way.

It will be noted that the materials used for the production of the finger 3, in particular for the insert 4, are preferably compatible with a foodstuffs or agro-foodstuffs use.

In a subsidiary way, the invention may also concern an ejector finger 3 for a device for supplying sorted closure elements 1 as described above.

1. A finger (3) for ejecting closure elements (1), comprising:
a body (31) provided with a base (30) and, on the opposite side, a distal end (33);
said distal end (33) comprising a front zone (34) for coming into contact with one of said closure elements (1) to be ejected,
wherein
the distal end (33) comprises an insert (4) provided with at least one front surface (40) sized so as at least partially to cover said front zone (34).

2. The ejector finger (3) as claimed in claim 1 further comprising a means for fixing at least said front zone (34) with the front surface (40), said fixing means comprising a core (43) extending at least in part inside said distal end (33).

3. The ejector finger (3) as claimed in claim 2, wherein said core (43) comprises at least one orifice (44) situated inside said distal end (33).

4. The ejector finger (3) as claimed in claim 3, wherein said orifice (44) is a through-orifice.

5. The ejector finger (3) as claimed in claim 2, wherein said insert (4) comprises a rear surface (42), said front surface (40) and said rear surface (42) being connected by said core (43).

6. The ejector finger (3) as claimed in claim 1, wherein said insert (4) comprises at least one rounded edge.

7. The ejector finger (3) as claimed in claim 1, further comprising at least one chamfer (5) reentrant from said base (30) to said distal end (33).

8. The ejector finger (3) as claimed in claim 1, wherein said body is made of a composite material, in particular of plastic material, whereas said insert is made of metal, in particular of stainless steel.

9. A device (2) for supplying sorted closure elements (1), comprising:
a volume (20) for bulk storage of said closure elements (1);
an elevator conveyor (21) in the form of a belt provided with an ascending run penetrating said storage volume (20);
said elevator conveyor (21) comprising on its exterior face a plurality of cleats (22) oriented transversely relative to said belt and spaced in such a manner as to determine a housing (23) between two adjacent cleats (22), each housing (23) taking up a plurality of said closure elements (1) during its passage inside said storage volume (20);
mechanical means (25) for ejecting the closure elements (1) present in each housing (23) on reaching the upper part of said elevator conveyor (21),
wherein said ejector means (25) comprise at least one ejector finger (3) as claimed in any one of preceding claims.

10. The supply device (2) as claimed in claim 9, further comprising a means (26) for moving said ejector means (25), said movement means (26) comprising a belt (260) supporting the base (30) of said at least one finger (3).

11. A method of manufacturing an ejector finger (3) as claimed in claim 1 by molding or by addition of material.

12. The method of manufacture as claimed in claim 11, wherein the method is effected by molding and in that:
said insert (4) is loaded into a mold;
said insert (4) is overmolded by injection of a composite or plastic material into said mold.

13. The ejector finger (3) as claimed in claim 3, wherein said insert (4) comprises a rear surface (42), said front surface (40) and said rear surface (42) being connected by said core (43).

14. The ejector finger (3) as claimed in claim 4, wherein said insert (4) comprises a rear surface (42), said front surface (40) and said rear surface (42) being connected by said core (43).

15. The ejector finger (3) as claimed in claim 2, wherein said insert (4) comprises at least one rounded edge.

16. The ejector finger (3) as claimed in claim 2, wherein said insert (4) comprises at least one rounded edge.

17. The ejector finger (3) as claimed in claim 3, wherein said insert (4) comprises at least one rounded edge.

18. The ejector finger (3) as claimed in claim 2, further comprising at least one chamfer (5) reentrant from said base (30) to said distal end (33).

19. The ejector finger (3) as claimed in claim 3, further comprising at least one chamfer (5) reentrant from said base (30) to said distal end (33).

20. The ejector finger (3) as claimed in claim 2, wherein said body is made of a composite material, in particular of plastic material, whereas said insert is made of metal, in particular of stainless steel.
